(19) United States
(12) Patent Application Publication
(10) Pub. No.: US 2025/0390797 A1
(43) Pub. Date: Dec. 25, 2025

(54) Model Training Method, Recommendation Method, Search Method, Computing Device, Storage Medium and Program Product

(71) Applicant: Hangzhou Alibaba International Internet Industry Co., Ltd., Hangzhou City (CN)

(72) Inventors: Ben CHEN, Hangzhou (CN); Xinxin WANG, Hangzhou (CN); Luwei YANG, Hangzhou (CN)

(21) Appl. No.: 19/249,390

(22) Filed: Jun. 25, 2025

(30) Foreign Application Priority Data
Jun. 25, 2024 (CN) 202410833381.5

(51) Int. Cl. G06N 20/00

(52) U.S. Cl. CPC G06N 20/00

(57) ABSTRACT

A model training method, a recommendation method, and a search method are provided. A first feature network and a second feature network are trained based on first association relationships between sample users and second sample objects with which the sample users have interactive behaviors, second association relationships between first sample objects and second sample objects that satisfy a similarity condition with the first sample objects, third association relationships between the first sample objects and the sample users, and training labels of whether the sample users have interactive behaviors with the second sample objects and the first sample objects respectively. The first feature network extracts collaborative features of a target user, and the second feature network extracts content features of a target object. A matching result of the content features and the collaborative features is used to determine whether to recommend the target object to the target user.

### CROSS REFERENCE TO RELATED PATENT APPLICATIONS

This application claims priority to Chinese Application No. 202410833381.5, filed on 25 Jun. 2024 and entitled “Model Training Method, Recommendation Method, Search Method, Computing Device, Storage Medium and Program Product,” which is incorporated herein by reference in its entirety.

### TECHNICAL FIELD

The present disclosure relates to the field of computer technologies, and in particular to model training methods, recommendation methods, search methods, computing devices, storage media, and program products.

### BACKGROUND

In online systems that provide objects for users to interact, such as e-commerce systems that provide products for users to purchase, there is usually a function of recommending products to users. At present, based on historical interactions information between users and products, a collaborative filtering algorithm can be used to determine whether to recommend a target product to a target user. For example, based on historical interaction behaviors of a target user, other users similar to the target user can be determined first, and products preferred by the other users can be used as target products. For another example, based on historical interaction behaviors of a target user, the target user's preferred products can be determined, and then products similar to the user's preferred products can be recommended to the target user.

However, this existing recommendation method fails to achieve accurate recommendations for users or products that do not have historical interaction behaviors, such as newly released products or newly registered users.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

The present disclosure provides a model training method, a recommendation method, a search method, a computing device, a storage medium, and a program product to solve the problem that it is difficult to make accurate recommendations for users or objects in existing technologies.

In implementations, the present disclosure provides a model training method, which includes:
determining a training data set, the training data set including first sample objects, second sample objects, and sample users;
establishing first association relationships between the sample users and second samples object that have interactive behaviors with the sample users;
establishing second association relationships between the first sample objects and second sample objects that meet a first similarity condition with the first sample objects;
establishing third association relationships between the first sample objects and the sample users based on a distribution of second sample objects that meet a second similarity condition with the first sample objects and have interactive behaviors with the sample users;
inputting user features of the sample users, object features of the second sample objects, and relational features representing the first association relationships into a first feature network;
inputting object features of the first sample objects, relational features representing the second association relationships, relational features representing the third association relationships, and collaborative features of the sample users and collaborative features of the second sample objects generated by the first feature network into a second feature network; and
training the first feature network and the second feature network using training labels of whether the sample users have interactive behaviors with the second sample objects and the first sample objects respectively, wherein:
the first feature network is used to extract collaborative features of a target user, the second feature network is used to extract content features of a target object, and a matching result of the content features and the collaborative features is used to determine whether to recommend the target object to the target user.

In implementations, the method further includes:
using an extraction network to extract the object features of the first sample objects from object information of the first sample objects, extract the object features of the second sample objects from object information of the second sample objects, and extract the user features of the sample users from user information of the sample users, wherein:
training the first feature network and the second feature network using the training labels whether the sample users have the interactive behaviors with the second sample objects and the first sample objects respectively includes:
training the extraction network, the first feature network, and the second feature network using the training labels of whether the sample users have the interactive behaviors with the second sample objects and the first sample objects respectively.

In implementations, establishing the second association relationships between the first sample objects and the second sample objects that meet the first similarity condition with the first sample objects includes:
for any first sample object, based on object features of the first sample object and object features of any second sample object, calculating a feature similarity between the first sample object and the second sample object; and
selecting a first number of second sample objects in a descending order of feature similarity to establish association relationships with the first sample object.

In implementations, establishing the third association relationships between the first sample objects and the sample users based on the distribution of the second sample objects that meet the second similarity condition with the first sample objects and have the interactive behaviors with the sample users includes:
determining, for any first sample object and any sample user, a second number of second sample objects that meet the second similarity condition with the first sample object;
determining a third number of second sample objects that have interactive behaviors with the sample user;
determining a fourth number of second sample objects that meet the second similarity condition with the first sample object and have interactive behaviors with the sample user;
calculating point mutual information according to respective occurrence probabilities of the second number of second sample objects, the third number of second sample objects, and the fourth number of second sample objects in a training data set; and
establishing a third association relationships between the first sample object and the sample user when the point mutual information is higher than a predetermined value.

In implementations, the first feature network is a graph convolutional network.

Inputting the user features of the sample users, the object features of the second sample objects and the relational features representing the first association relationships into the first feature network includes:
using the user features of the sample users and the object features of the second sample object as nodes to generate a first node feature matrix;
constructing edges between the sample users and the second sample objects to generate a first adjacency matrix according to the first association relationships between the sample users and the second sample objects; and
inputting the first node feature matrix and the first adjacency matrix into the first feature network.

In implementations, the second feature network is a graph convolutional network.

Inputting the object features of the first sample objects, the relational features representing the second association relationships, the relational features representing the third association relationships, the collaborative features of the sample users and the collaborative features of the second sample objects generated by the first feature network into the second feature network includes:
using the object features of the first sample objects as nodes to generate a second node feature matrix;
using the collaborative features of the sample users generated by the first feature network as nodes to generate a third node feature matrix;
using the collaborative features of the second sample objects as nodes to generate a fourth node feature matrix;
constructing edges between the first sample objects and the second sample objects to generate a first candidate adjacency matrix based on the second association relationships between the first sample objects and the second sample objects;
constructing edges between the sample users and the first sample objects to generate a second candidate adjacency matrix based on the third association relationships between the sample users and the first sample objects;
combining the first candidate adjacency matrix and the second candidate adjacency matrix to obtain a second adjacency matrix; and
inputting the second node feature matrix, the third node feature matrix, the fourth node feature matrix, and the second adjacency matrix into the second feature network.

In implementations, training the first feature network and the second feature network using the training labels of whether the sample users have interaction behaviors with the second sample objects and the first sample objects respectively includes:
using the training labels of whether the sample users have interaction behaviors with the second sample objects and the first sample objects respectively, determining triplets composed of the sample users, respective first positive sample objects having interaction behaviors with the sample users, and respective first negative sample objects having no interaction behaviors with the sample users, and triplets composed of the sample users, second positive sample objects having interaction behaviors with the sample users, and second negative sample objects having no interaction behaviors with the sample users;
calculating a first loss value using a first loss function according to collaborative features or content features corresponding to the triplets;
calculating a second loss value using a second loss function according to content features of the first sample objects and collaborative features of the second sample objects that meet a third similarity condition with the first sample objects;
determining a target loss value according to the first loss value and the second loss value; and
adjusting model parameters corresponding to the first feature network and the second feature network respectively based on the target loss value.

In implementations, extracting the object features of the first sample objects, the object features of the second sample objects, and the user features of the sample users using the extraction network includes:
extracting the object features of the first sample objects and the object features of the second sample objects using a first sub-extraction network; and
extracting the user features of the sample users using a second sub-extraction network.

In implementations, inputting the user features of the sample users, the object features of the second sample objects, and the relational features representing the first association relationships into the first feature network includes:
inputting the user features of the sample users, the object features of the second sample objects, and the relational features representing the first association relationship into the first feature network, so as to use the first feature network to generate, for any second sample object, collaborative features of the second sample object based on the object features of the second sample objects, the user features of the sample users having the first association relationships with the second sample objects, and the relational features representing the first association relationships, and to generate, for any sample user, collaborative features of the sample user based on the user features of the sample users, the object features of the first sample objects having the first association relationships with the sample users, and the relational features.

In implementations, inputting the second node feature matrix, the third node feature matrix, the fourth node feature matrix, and the second adjacency matrix into the second feature network includes:
inputting the second node feature matrix, the third node feature matrix, the fourth node feature matrix and the second adjacency matrix into the second feature network, and performing feature processing operations in intermediate layers of the second feature network to obtain candidate features of the first sample objects and candidate features of the second sample objects; and
fusing, in an output layer of the second feature network, the candidate features of the first sample object and the candidate features of the second sample object respectively output by the intermediate layers to obtain content features of the first sample objects.

In implementations, the present disclosure provides a recommendation method, which includes:
determining a target user;
using a first feature network to extract collaborative features of the target user;
obtaining content features of the target object extracted by a second feature network;
determining a degree of matching between the target user and the target object based on the collaborative features and the content features; and
recommending the target object to the target user if the degree of matching meets a matching condition, wherein:
by training in combination with training labels of whether sample users have interaction behaviors with second sample objects and first sample objects respectively, the first feature network is obtained using user features of the sample users, object features of the second sample objects, and relational features representing first association relationships as input data, and the second feature network is obtained using object features of the first sample objects, relational features representing second association relationships, relational features representing third association relationships, and collaborative features of the sample users and collaborative features of the second sample objects generated by the first feature network as input data; the first association relationships are constructed based on whether the sample users have interaction behaviors with the second sample objects; the second association relationships are constructed based on whether the first sample objects and the second sample objects meet a first similarity condition; and the third association relationships are constructed based on a distribution of the second sample objects that meet a second similarity condition with the first sample objects and have interaction behaviors with the sample users.

In implementations, the method further includes:
extracting initial features of the target user using an extraction network based on user information of the target user.

Using the first feature network to extract the collaborative features of the target user includes:
extracting the collaborative features of the target user using the first feature network based on the initial features.

In implementations, determining the target user includes:
determining a target user who has successfully registered or entered a target page or performed a target behavior.

In implementations, the method further includes:
extracting the content features of the target object using the second feature network in response to a publishing event of the target object.

In implementations, recommending the target object to the target user includes:
sending recommendation prompt information of the target object to a user terminal of the target user; or
sending the recommendation prompt information of the target object based on a communication account corresponding to the target user; or
sending the target object as a search result to the user terminal of the target user.

In implementations, the present disclosure provides a search method, which includes:
determining, in response to a search request of a target user, a target object based on search information in the search request;
using a first feature network to extract collaborative features of the target user;
obtaining content features of the target object extracted using a second feature network;
determining a degree of match between the target user and the target object based on the collaborative features and the content features; and
sending the target object as a search result to a user terminal of the target user if the degree of matching meets a matching condition, wherein:
by training in combination with training labels of whether sample users have interaction behaviors with second sample objects and first sample objects respectively, the first feature network is obtained using user features of the sample users, object features of the second sample objects, and relational features representing first association relationships as input data, and the second feature network is obtained using object features of the first sample objects, relational features representing second association relationships, relational features representing third association relationships, and collaborative features of the sample users and collaborative features of the second sample objects generated by the first feature network as input data; the first association relationships are constructed based on whether the sample users have interaction behaviors with the second sample objects; the second association relationships are constructed based on whether the first sample objects and the second sample objects meet a first similarity condition; and the third association relationships are constructed based on a distribution of the second sample objects that meet a second similarity condition with the first sample objects and have interaction behaviors with the sample users.

In implementations, the present disclosure provides a computing device, which includes: a processing component and a storage component, and the storage component storing one or more computer instructions, the one or more computer instructions being configured to be called and executed by the processing component to implement the model training method described in the first aspect, the recommendation method described in the second aspect, or the search method described in the third aspect.

In implementations, the present disclosure provides a computer storage medium storing a computer program, and when the computer program is executed by a computer, the model training method described in the first aspect, the recommendation method described in the second aspect, or the search method described in the third aspect is implemented.

In implementations, the present disclosure provides a computer program product, which includes computer program/instructions, and when the computer program/instructions is/are executed by a computer, the model training method described in the first aspect, the recommendation method described in the second aspect, or the search method described in the third aspect is implemented.

In the embodiments of the present disclosure, a training data set is first determined; wherein the training data set includes first sample objects, second sample objects, and sample users. First association relationships are established between the sample users and second sample objects that have interactive behaviors with the sample users. Second association relationships are established between the first sample objects and second sample objects that meet a first similarity condition with the first sample objects. Third association relationships are established between the first sample objects and the sample users according to a distribution of second sample objects that meet a second similarity condition with the first sample objects and have interactive behaviors with the sample users. User features of the sample users, object features of the second sample objects, and relational features representing the first association relationships are input into a first feature network. Object features of the first sample objects, relational features representing the second association relationships, relational features representing the third association relationships, and collaborative features of the sample users and collaborative features of the second sample objects generated by the first feature network are input into a second feature network. The first feature network and the second feature network are trained in combination with training labels of whether the sample users have interactive behaviors with the second sample objects and the first sample objects respectively. The first feature network is used to extract collaborative features of a target user, and the second feature network is used to extract content features of a target object. A matching result of the content features and the collaborative features is used to determine whether to recommend the target object to the target user. The second sample objects can represent objects with historical interaction behavior, and the first sample objects can represent objects without historical interaction behavior, so that the first feature network is trained in combination with historical interaction information of the second sample objects and the sample users. As such, the first feature network can be used to extract collaborative features including historical interaction information to train the second feature network in combination with the collaborative features and the association relationships, so that the second feature network can consider features of objects themselves and features of users who may interact therewith, so as to improve content features of an extracted object and improve the feature quality of the content features. Furthermore, since the quality of content features of a target object is improved, a matching result of the content features of the target object and collaborative features of a target user extracted by using the first feature network can help achieve accurate recommendations.

These aspects or other aspects of the present disclosure will be more concise and easier to be understood in the description of the following embodiments.

### BRIEF DESCRIPTION OF THE DRAWINGS

In order to more clearly illustrate technical solutions in the embodiments of the present disclosure or existing technologies, the following is a brief introduction to the drawings required for use in the description of the embodiments or the existing technologies. Apparently, the drawings described below are some embodiments of the present disclosure. For one of ordinary skill in the art, other drawings can also be obtained based on these drawings without making any creative work.

FIG. 1 shows a flowchart of an exemplary model training method provided by the present disclosure.

FIG. 2 shows a diagram of a model structure of the embodiments of the present disclosure in an actual application.

FIG. 3 shows a flowchart of an exemplary recommendation method provided.

FIG. 4 shows a schematic diagram of scene interaction of the embodiments of the present disclosure in an actual application.

FIG. 5 shows a flowchart of an exemplary search method provided by the present disclosure.

FIG. 6 shows a structural schematic diagram of an exemplary model training apparatus provided by the present disclosure.

FIG. 7 shows a structural schematic diagram of an exemplary recommendation apparatus provided by the present disclosure.

FIG. 8 shows a structural schematic diagram of an exemplary computing device provided by the present disclosure.

### DETAILED DESCRIPTION

In order to enable one skilled in the art to better understand the solutions of the present disclosure, the technical solutions in the embodiments of the present disclosure will be clearly and completely described below in conjunction with the drawings in the embodiments of the present disclosure.

In some processes described in the specification and claims of the present disclosure and the above drawings, multiple operations appearing in a specific order are included. However, it needs to be clearly understood that these operations may not be executed according to the order in which they appear in this article or may be executed in parallel. Sequence numbers of operations, such as 101, 102, etc., are only used to distinguish different operations, and the sequence numbers themselves do not represent any execution order. In addition, these processes may include more or fewer operations, and these operations may be executed in sequence or in parallel. It needs to be noted that descriptions such as “first”, “second”, etc., in this text are used to distinguish different messages, devices, modules, etc., and do not represent an order of precedence, nor do they limit “first” and “second” to different types.

The technical solutions of the embodiments of the present disclosure can be applied to recommendation scenarios of an online system that provides object interactions, such as an e-commerce system that provides object transactions.

In a traditional way, in an online system that provides objects for users to interact, taking an e-commerce system as an example, a decision about whether to recommend a current product to a user is usually made based on historical interaction behaviors between the current product and the past users, such as categories, industries, prices, etc. of recently purchased products. However, the latest released products do not have any historical behavior information, so it is difficult to achieve accurate recommendation using traditional collaborative filtering algorithms.

In order to achieve accurate recommendation, the inventors have proposed the technical solutions of the present disclosure after some research. In the embodiments of the present disclosure, a training data set is determined, wherein the training data set includes first sample objects, second sample objects, and sample users. First association relationships are established between the sample users and second sample objects that has an interaction behavior with the sample users. Second association relationships are established between the first sample objects and second sample objects that meet a first similarity condition with the first sample objects. Third association relationships are established between the first sample objects and the sample users according to a distribution of second sample objects that meet a second similarity condition with the first sample objects and have an interaction behavior with the sample users. User features of the sample users, object features of the second sample objects, and relational features representing the first association relationships are input into a first feature network. The object features of the first sample objects, relational features representing the second association relationships, relational features representing the third association relationships, and collaborative features of the sample users and collaborative features of the second sample objects generated by the first feature network are input into a second feature network. The first feature network and the second feature network are trained in combination with training labels of whether the sample users have interaction behaviors with the second sample objects and the first sample objects respectively. The first feature network is used to extract collaborative features of a target user, and the second feature network is used to extract content features of a target object. A matching result of the content features and the collaborative features is used to determine whether to recommend the target object to the target user. The second sample objects can represent objects with historical interaction behaviors, and the first sample objects can represent objects with no historical interaction behaviors, so that the first feature network is trained in combination with historical interaction information of the second sample objects and the sample users, to enable the first feature network to be used to extract collaborative features including historical interaction information, and to train the second feature network in combination with the collaborative features and the association relationships. As such. the second feature network can consider features of objects themselves and features of users who may interact therewith, so as to improve content features of an extracted object and improve the feature quality of the content features. Furthermore, since the quality of content features of a target object is improved, a result of matching between the content features of the target object and collaborative features of a target user extracted by using the first feature network can help achieve accurate recommendations.

Combined with the drawings in the embodiments of the present disclosure, the technical solutions in the embodiments of the present disclosure will be clearly and completely described below. Apparently, the described embodiments represent only part and not all of the embodiments of the present disclosure. Based on these embodiments in the present disclosure, all other embodiments obtained by one skilled in the art without making any creative work fall within the scope of protection of the present disclosure.

It needs to be noted that the embodiments of the present disclosure may involve the use of user data. In practical applications, user-specific personal data can be used in the solutions described herein within the scope permitted by applicable laws and regulations in accordance with the requirements of applicable laws and regulations of the country (for example, the user's explicit consent, the user's effective notification, etc.).

It needs to be noted that user information (including but not limited to user device information, user personal information, etc.) and data (including but not limited to data for analysis, stored data, displayed data, etc.) involved in the present disclosure are all information and data authorized by users or fully authorized by all parties, and the collection, use and processing of relevant data need to comply with the relevant laws and regulations and standards of relevant countries and regions, and provide corresponding operation portals for users to choose to authorize or refuse.

It needs to be noted that the technical solutions of the embodiments of the present disclosure are applicable to network virtual environments. The users described generally refer to “virtual users”. A real user can register a user account in a server through registration to obtain a user identity in a network environment.

Implementation details of the technical solutions of the embodiments of the present disclosure are described in detail below.

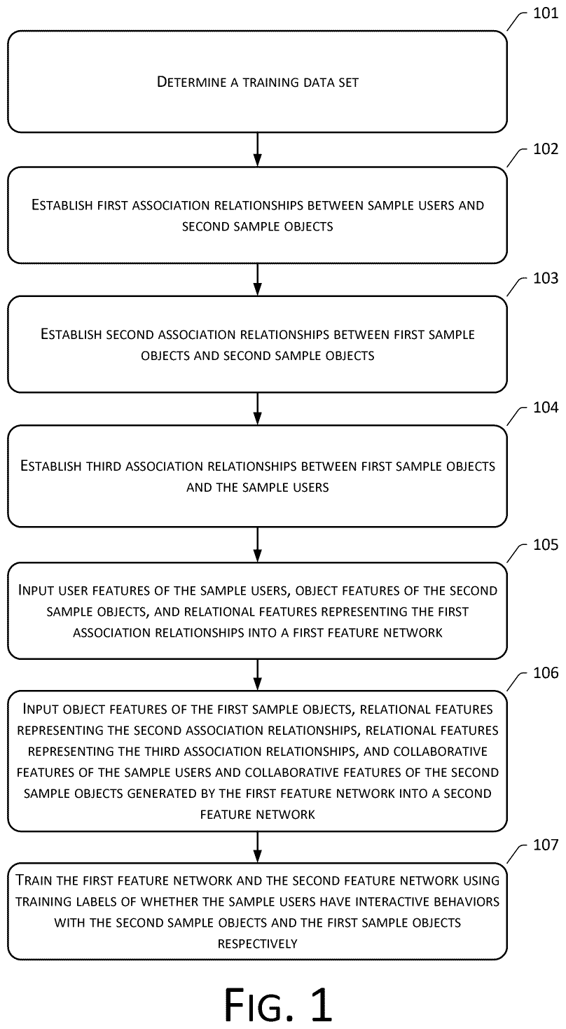

FIG. 1 is a flowchart of an exemplary model training method provided by the present disclosure, and the method may include the following steps:

101: Determine a training data set.

The training data set includes first sample objects, second sample objects, and sample users.

A sample user may refer to a user who has an interactive behavior with a first sample object or a second sample object.

In an e-commerce scenario, a sample object may refer to a sample commodity. For example, commodities that have an interactive behavior within a predetermined historical period, such as the past 30 days, may be used as sample objects, and a certain number of users who have interacted with the sample objects and the number of interactive behaviors meets an interactive requirement may be used as sample users. According to training requirements, the sample objects may be divided into a first predetermined number of first sample objects and a second predetermined number of second sample objects. When the embodiments of the present disclosure are used in a new product (the latest released object with no historical interactive behavior) recommendation scenario, the second sample objects can be considered as old products (objects with historical interactive behaviors), and the first sample objects can be considered as new products.

In practical applications, an interactive behavior may refer to purchase, browsing, collection, and/or purchase addition, etc.

102: Establish first association relationships between sample users and second sample objects that have an interactive behavior with the sample users.

103: Establish second association relationships between first sample objects and second sample objects that meets first similarity condition with the first sample objects.

104: Establish third association relationships between the first sample objects and the sample users based on a distribution of second sample objects that meet a second similarity condition with the first sample objects and have interactive behaviors with the sample users.

105: Input user features of the sample users, object features of the second sample objects, and relational features representing the first association relationships into a first feature network.

106: Input object features of the first sample objects, relational features representing the second association relationships, relational features representing the third association relationships, and collaborative features of the sample users and collaborative features of the second sample objects generated by the first feature network into a second feature network.

107: Train the first feature network and the second feature network using training labels of whether the sample users have interactive behaviors with the second sample objects and the first sample objects respectively.

The first feature network is used to extract collaborative features of a target user, and the second feature network is used to extract content features of a target object. A matching result of the content features and the collaborative features can be used to determine whether to recommend the target object to the target user.

In implementations, the association relationships between the first sample objects and the second sample objects are constructed according to object similarity, the association relationships between the second sample objects and the sample users are constructed through historical interaction information between the second sample objects and the sample users, and the association relationships between the first sample objects and the sample users are constructed in combination with the object similarity and a distribution of second sample objects, so as to train and obtain the first feature network and the second feature network accordingly. As such, the first feature network can accurately extract collaborative features of a user, and the second feature network can accurately extract content features of an object, thereby improving the feature quality of the collaborative features and the content features. Since the quality of content features of a target object is improved, a matching result of the content features of the target object and collaborative features of a target user extracted by using the first feature network can help achieve accurate recommendation.

In implementations, the method can further include: using an extraction network to extract object features of the first sample objects from object information of the first sample objects, extract object features of the second sample objects from object information of the second sample objects, and extract user features of the sample users from user information of the sample users.

Object information of a sample object may include an image of the sample object, detailed information such as name, origin, price, etc., and associated merchant information such as one or more of name, industry, etc., that is, the object information may be represented in a form of image and/or text.

User information of a sample user may include one or more pieces of attribute information such as ID (identification), age, or region of the sample user. In a practical application, in order to simplify calculation, the user information may refer to a user ID.

In implementations, the extraction network, the first feature network, and the second feature network may be trained together. In combination with training labels of whether the sample users have interaction behaviors with the second sample objects and the first sample objects respectively, training the first feature network and the second feature network may include: training the extraction network, the first feature network, and the second feature network in combination with the training labels of whether the sample users have interaction behaviors with the second sample objects and the first sample objects respectively.

In implementations, using the extraction network to extract the object features of the first sample objects, the object features of the second sample objects, and the user features of the sample users may include: extracting the object features of the first sample objects and the object features of the second sample objects using a first sub-extraction network; and extracting the user features of the sample users using a second sub-extraction network.

The object features and the user features that are extracted may be in a form of feature vectors.

The second sub-extraction network may extract the user features of the sample users using a mapping matrix.

The first sub-extraction network may be composed of a frozen pre-trained encoder and a trainable content encoder including two fully connected layers, and may extract the object features of the first sample objects and the object features of the second sample objects from object information of the first sample objects. For example, an object feature X_{I} of an sample object may be expressed according to the following formula (1):

$${X}_{1} = δ ( {VW}_{1} + {b}_{1} ) {W}_{2} + {b}_{2} ) \qquad ( 1 )$$

wherein V represents an output obtained by inputting object information of sample objects into a pre-trained encoder, W₁ and W₂ represent linear mapping matrices corresponding to two fully connected layers, b₁ and b₂ represent bias items corresponding to the two fully connected layers, (VW₁+b₁) represents an output after inputting V into the first fully connected layer of a trainable content encoder, and δ(·) may represent a LeakyRelu (Leaky Rectified Linear Unit) function. Apparently, the trainable content encoder can be composed of one fully connected layer or more than two fully connected layers, which is not limited by the present disclosure. It needs to be noted that the first sub-extraction network and the second sub-extraction network can also be implemented using other machine learning models, and the present disclosure does not have any limitation thereon.

The first association relationships, the second association relationships, and the third association relationships as described above can be represented through a feature form. In order to better characterize the association relationships, in implementations, the first feature network can be implemented as a graph convolutional network. A graph convolutional network (GCN) is a deep learning model for image data. The principles of a graph convolutional network mainly come from traditional convolutional neural networks (CNN). A CNN mainly processes image data and extracts local features of images by local receptive fields and weight sharing. A graph convolutional network extracts features on graph structure data by defining a method similar to convolution operation. A core idea of a graph convolutional network is to use an adjacency matrix to describe a topological structure of a graph, and gradually propagate and aggregate information of nodes through multi-layer graph convolution operations. In a graph convolution operation of each layer, weights of neighboring nodes of nodes and edges therebetween are considered to update and aggregate features of the nodes. In this way, GCN can learn low-dimensional representations of nodes in the graph, which can be used for downstream tasks such as node classification, link prediction, etc.

Inputting the user features of the sample users, the object features of the second sample objects, and the relational features representing the first association relationships into the first feature network may include: using the user features of the sample users and the object features of the second sample objects as nodes to generate a first node feature matrix; constructing edges between the sample users and the second sample objects according to the first association relationships between the sample users and the second sample objects to generate a first adjacency matrix; and inputting the first node feature matrix and the first adjacency matrix into the first feature network.

In other words, the first adjacency matrix can be used to represent the first association relationships. If a first association relationship between a sample user and a second sample object exists, a corresponding matrix item is 1, otherwise it is 0. A matrix item of an i-th row and a j-th column in the first node feature matrix can represent a first association relationship between an i-th sample user and a j-th second sample object, and apparently, can also represent a first sample relationship between an i-th second sample object and a j-th sample user. The present disclosure does not specifically limit references to rows or columns.

In implementations, inputting the user features of the sample users, the object features of the second sample objects, and the relational features representing the first association relationships into the first feature network may include: inputting the user features of the sample users, the object features of the second sample objects, and the relational features representing the first association relationships into the first feature network, so as to generate, for any second sample object, collaborative features of the second sample object using the first feature network based on the object features of the second sample objects, the user features of the sample users having the first association relationships with the second sample objects, and the relational features of the first association relationships, and generate, for any sample user, collaborative features of the sample user based on the user features of the sample users, the object features of the first sample objects having the first association relationships with the sample users, and the relational features.

For example, the first feature network may be a LightGCN (Light Graph Convolutional Network). The first feature network can generate collaborative features of a second sample object and collaborative features of a sample user according to the following formula (2) and formula (3):

$${Z}_{{I}_{P}} = LightGCN ( {X}_{{I}_{P}} , \{ {X}_{{U}_{n}} \vert n ϵ U ( {i}_{p} ) \} ) \qquad ( 2 )$$

$${Z}_{{U}_{q}} = LightGCN ( {X}_{{U}_{q}} , \{ {X}_{{I}_{m}} \vert m ϵ I ( {u}_{q} ) \} ) \qquad ( 3 )$$

wherein, X₁_{ₚ}, represents object features of a second sample object p, U(iₚ) represents A set of sample users that have interactive behaviors with the second sample object p, X_{U}_{ₙ} represents user features of sample users that have interactive behaviors with the second sample object p, X_{U}_{_{q}} represents user features of a sample user q, I(u_{q}) represents the set of second sample objects that have interactive behaviors with the sample user q, and X_{I}_{ₘ} represents object features of a second sample object that has interactive behavior with the sample user q, Z_{U}_{_{q}} represents collaborative features of the sample user generated by the first feature network, and Z_{I}_{ₚ} represents collaborative features of the second sample object generated by the first feature network.

In implementations, establishing the second association relationships between the first sample objects and the second sample objects that meet the first similarity condition with the first sample objects may include: calculating, for any first sample object, based on object features of the first sample object and object features of any second sample object, a feature similarity between the first sample object and the second sample object; and selecting a first number of second sample objects to establish association relationships with the first sample object in a descending order of feature similarity.

For example, a feature similarity between a first sample object and a second sample object can be calculated according to the following cosine similarity calculation formula (4):

$$Sim ( j , k ) = \frac{{v}_{j} \cdot {v}_{k}^{T}}{{‖ {v}_{j} ‖}_{2} * {‖ {v}_{k} ‖}_{2}} \qquad ( 4 )$$

wherein Sim(j, k) is a feature similarity between a first sample object j and a second sample object k, vⱼ represents an object feature of the first sample object j,

$${v}_{k}^{T}$$

represents a transposition of an object feature of the second sample object k, ∥vⱼ∥₂ represents a vector length of the object feature of the first sample object j, and [symbol] ∥vₖ∥₂ represents a vector length of the object feature of the second sample object k.

Apparently, other similarity calculation formulas can also be used to calculate the feature similarity between the first sample object and the second sample object, such as an Euclidean distance, a Pearson correlation coefficient, or a Hatton distance, etc., which are not limited in the present disclosure.

In implementations, establishing the third association relationships between the sample users and the first sample objects according to the distribution of the second sample objects that meet the second similarity condition with the first sample objects and have interactive behaviors with the sample users may include: for any first sample object and any sample user, determining a second number of second sample objects that meet the second similarity condition with the first sample object; determining a third number of second sample objects that have interactive behaviors with the sample user; determining a fourth number of second sample objects that meet the second similarity condition with the first sample object and have interactive behaviors with the sample user; calculating point mutual information according to respective occurrence probabilities of the second number of second sample objects, the third number of second sample objects, and the fourth number of second sample objects in a training data set; and establishing a third association relationship between the first sample object and the sample user when the point mutual information is higher than a predetermined value.

For example, the point mutual information between a sample user m and a first sample object j can be calculated by referring to the following formula (5):

$$PMI ( m , j ) = log \frac{p ( {u}_{m} , {i}_{j} )}{p ( {u}_{m} ) \cdot p ( {i}_{j} )} wherein p ( {u}_{m} ) = \frac{I ( {u}_{m} )}{\vert I \vert} , p ( {i}_{j} ) = \frac{I ( {i}_{j} )}{\vert I \vert} , p ( {u}_{m} , {i}_{j} ) = \frac{I ( {u}_{m} ) ⋂ I ( {i}_{j} )}{\vert I \vert} \qquad ( 5 )$$

∥I∥ can represent the number of sample objects in a training data set, I(uₘ) can represent second sample objects that have interactive behaviors with a sample user m, I(iⱼ) can represent the second number of second sample objects that meet the second similarity condition with a first sample object j, p(uₘ) is the probability of occurrence of the second sample objects that have interactive behaviors with the sample user m in the training data set, and p(iⱼ) is the probability of occurrence of the second number of second sample objects that meet the second similarity condition with the first sample object j. p(uₘ, iⱼ) represents the probability of occurrence of second sample objects that meets the second similarity condition with the first sample object j and have interactive behaviors with the sample user m in the training data set. I(uₘ)∩I(iⱼ) represents second sample objects that meets the second similarity condition with the first sample object j and have interactive behaviors with the sample user m.

When the point mutual information PMI(m, j) is higher than a predetermined value, a third association relationship is established between the first sample object j and the sample user m.

The point mutual information as described above can be combined with the similarity between the first sample object and the second sample object and interaction information between the second sample object and the sample user to establish a third association relationship between the first sample object and the sample user, which is helpful to improve content features of a first sample object that has no interaction behavior with the sample user.

In order to better characterize the association relationships, in implementations, the first feature network can be implemented as a graph convolutional network, and the second feature network can be implemented as a graph convolutional network. A graph convolutional network (GCN) is a deep learning model for image data. The principles of a graph convolutional network mainly come from traditional convolutional neural networks (CNN). A CNN mainly processes image data and extracts local features of images through local receptive fields and weight sharing. A graph convolutional network extracts features on graph structure data by defining a method similar to convolution operation. The core idea of a graph convolutional network is to use adjacency matrix to describe a topological structure of a graph, and gradually propagate and aggregate information of nodes through multi-layer graph convolution operations. In a graph convolution operation of each layer, weights of neighboring nodes of nodes and edges therebetween are considered to update and aggregate features of the nodes. In this way, the GCN can learn low-dimensional representations of nodes in the graph, which can be used for downstream tasks such as node classification, link prediction, etc.

In implementations, inputting the object features of the first sample objects, the relational features representing the second association relationships, the relational features representing the third association relationships, and the collaborative features of the sample users and the collaborative features of the second sample objects generated by the first feature network into the second feature network may include: using the object features of the first sample objects as nodes to generate a second node feature matrix; using the collaborative features of the sample users generated by the first feature network as nodes to generate a third node feature matrix; using the collaborative features of the second sample objects as nodes to generate a fourth node feature matrix; constructing edges between the first sample objects and the second sample objects according to the second association relationships between the first sample objects and the second sample objects to generate a first candidate adjacency matrix; constructing edges between the sample users and the first sample objects according to the third association relationships between the sample users and the first sample objects to generate a second candidate adjacency matrix; combining the first candidate adjacency matrix and the second candidate adjacency matrix to obtain a second adjacency matrix; inputting the second node feature matrix, the third node feature matrix, the fourth node feature matrix, and the second adjacency matrix into the second feature network.

If a second association relationship between a first sample object and a second sample object exists, a corresponding matrix item in the first candidate adjacency matrix is 1, otherwise it is 0. For example, a matrix item of a m-th row and a n-th column in the first candidate adjacency matrix can represent a second association relationship between a m-th first sample object and a n-th second sample object, and apparently can also represent a second association relationship between a m-th second sample object and a n-th first sample object. If a third association relationship between a sample user and a first sample object exists, a corresponding matrix item in the second candidate adjacency matrix is 1, otherwise it is 0. For example, a matrix item of a m-th row and a n-th column in the second candidate adjacency matrix can represent a third association relationship between a m-th sample user and a n-th first sample object, and apparently can also represent a second association relationship between a m-th first sample object and a n-th sample user. The present disclosure does not specifically limit references to rows or columns. The third node feature matrix can refer to the collaborative features Z_{U}_{_{q}} of the sample users, and the fourth node feature matrix can refer to the collaborative features Z_{I}_{ₚ} of the second sample objects.

In addition, the first candidate adjacency matrix and the second candidate adjacency matrix can be combined with reference to the following formula (6) to obtain the second adjacency matrix:

$${A}_{P A} = {[ \begin{matrix}{E}_{u} & {A}_{p} \\ {A}_{p}^{T} & {A}_{c}\end{matrix} ]}_{( \vert U \vert + [ I ] ) \times ( \vert U \vert + [ I ] )} \qquad ( 6 )$$

wherein A_{c} represents the first candidate adjacency matrix, Aₚ represents the second candidate adjacency matrix, Aₚ^{T} represents the transpose of the second candidate adjacency matrix, Eᵤ represents an identity matrix of |U| rows and |U| columns with matrix items on the main diagonal being 1 and the remaining matrix items being 0. The second adjacency matrix

$${A}_{P A} = [ \begin{matrix}{E}_{u} & {A}_{p} \\ {A}_{p}^{T} & {A}_{c}\end{matrix} ]$$

is obtained by combining the first candidate adjacency matrix A_{c}, the second candidate adjacency matrix Aₚ, and the identity matrix Eᵤ, |I| represents the number of sample objects, and |U| represents the number of sample users. The second adjacency matrix may be composed of (|U|+|I|) rows and (|U|+|I|) columns.

In implementations, inputting the second node feature matrix, the third node feature matrix, the fourth node feature matrix, and the second adjacency matrix into the second feature network may include: inputting the second node feature matrix, the third node feature matrix, the fourth node feature matrix, and the second adjacency matrix into the second feature network, and performing feature processing operations in an intermediate layer in the second feature network to obtain candidate features of the first sample objects and candidate features of the second sample objects; and performing, in an output layer of the second feature network, fusion processing on candidate features of the first sample objects and candidate features of the second sample objects output by multiple intermediate layers to obtain content features of the first sample object.

In implementations, an intermediate layer of the second feature network may perform feature processing operations according to the following formula (7).

$$[ \begin{matrix}{H}_{U}^{( I + 1 )} \\ {H}_{IW}^{( l + 1 )} \\ {X}_{IC}^{( l + 1 )}\end{matrix} ] = {A}_{P A} {D}_{P A}^{- 1} [ \begin{matrix}{H}_{U}^{( l )} \\ {H}_{IW}^{( l )} \\ {X}_{IC}^{( l )}\end{matrix} ] + {E}_{PA} {D}_{PA}^{- 1} [ \begin{matrix}{Z}_{U} \\ {X}_{I}\end{matrix} ] \qquad ( 7 )$$

wherein,

$${D}_{P A}^{- 1}$$

represents an inverse matrix of a degree matrix of the second adjacency matrix A_{PA}, E_{PA} represents an identity matrix with the same dimension as A_{PA},

$${H}_{U}^{( 0 )}$$

is collaborative features Z_{U} of the sample users, and

$${H}_{IW}^{( 0 )}$$

is collaborative features Z_{I} of the second sample objects,

$${H}_{U}^{( l )}$$

represents a collaborative feature matrix of the sample users output by a I-th layer,

$${H}_{IW}^{( l )}$$

represents candidate features of the second sample objects output by the I-th layer,

$${X}_{IC}^{( l )}$$

represents candidate features of the first sample objects output by the I-th layer, X_{I} represents object features of the sample objects,

$${H}_{U}^{( l + 1 )}$$

represents candidate features of the sample users output by a (I+1)-th layer,

$${H}_{IW}^{( l + 1 )}$$

represents candidate features of the second sample objects output by the (I+1)-th layer, and

$${X}_{IC}^{( l + 1 )}$$

represents candidate features of the first sample objects output by the (I+1)-th layer.

In addition, in order to avoid over-smoothing problems of graph convolutional networks, some matrix items in the collaborative feature matrix Z_{I} of the second sample objects or the collaborative feature matrix Z_{U} of the sample users can be randomly set to 0.

The output layer of the second feature network can fuse candidate features of the first sample objects and candidate features of the second sample objects output by multiple intermediate layers according to the following formulas (8) and (9) to obtain content features of the first sample objects:

$${Q}_{1} = \frac{1}{M} {\sum }_{i = 0}^{M} ( [ \begin{matrix}{H}_{IW}^{( i )} \\ {H}_{IC}^{( i )}\end{matrix} ] ) ) \qquad ( 8 )$$

wherein M represents the number of layers of the second feature network. Candidate features

$${H}_{IC}^{( i )}$$

of the first sample objects and candidate features

$${H}_{IW}^{( i )}$$

of the second sample objects output by each intermediate layer can be fused, for example, added together, to obtain fused features, and respective fused features of multiple intermediate layers are then averaged to obtain candidate features Q_{I} of the first sample objects.

$${P}_{I} = δ ( {Q}_{I} {W}_{1}^{′} + {b}_{1}^{′} ) {W}_{2}^{′} + {b}_{2}^{′} \qquad ( 9 )$$

wherein

$${W}_{1}^{′} and {W}_{2}^{′}$$

represent linear mapping matrices corresponding to two fully connected layers, and

$${b}_{1}^{′} and {b}_{2}^{′}$$

represent bias items corresponding to the two fully connected layers.

Apparently, it needs to be noted that the first feature network and the second feature network can be implemented not only by graph convolutional networks, but also by convolutional neural networks (CNNs), fully connected networks (FCNs), or self-attention mechanisms, etc. The present disclosure does not have any limitations thereon.

In implementations, in order to further improve the accuracy, training the first feature network and the second feature network using the training labels of whether the sample users have the interaction behaviors with the second sample objects and the first sample objects respectively may include: in combination with the training labels of whether the sample users have interaction behaviors with the second sample objects and the first sample objects respectively, determining triplets including the sample users, first positive sample objects having interaction behaviors with the sample users, and first negative sample objects not having interaction behaviors with the sample users, and triplets including the sample users, second positive sample objects having interaction behaviors with the sample users, and second negative sample objects not having interaction behaviors with the sample users; calculating a first loss value using a first loss function according to collaborative features or content features corresponding to the triplets; calculating a second loss value using a second loss function according to content features of the first sample objects and collaborative features of the second sample objects that meet the third similarity condition with the first sample objects; determining a target loss value based on the first loss value and the second loss value; and adjusting respective model parameters corresponding to the first feature network and the second feature network based on the target loss value.

In implementations, determining the target loss value based on the first loss value and the second loss value may be to perform weighted fusion of the first loss value and the second loss value to obtain the target loss value. In practical applications, the target loss value may also be obtained using L2 loss value calculation. For example, the target loss value L may be determined according to the following formula (10):

$$L = {L}_{R} + γ {L}_{S} + μ {‖ θ ‖}_{2} \qquad ( 10 )$$

wherein L_{R} represents the first loss value, L_{S} represents the second loss value, ϑ represents the model parameters of the second feature network, ∥θ∥₂ represents L2 regularization, where

$${‖ θ ‖}_{2} = \frac{1}{2} \sum {θ}^{2} ,$$

γ and μ may represent weight coefficients.

The first loss value may be used to constrain the content features and the collaboration features of the sample objects to have the same influence on a target user, which helps to build relationships between the sample users and the sample objects.

In a practical application, the first loss value L_{R} can be calculated according to the following first loss function formula (11):

$${L}_{R} = \frac{1}{⌈ O ⌉} ( {\sum }_{( {u}_{h} , {i}_{m} , {i}_{n} ) ∈ O} α \cdot log ( \frac{{e}^{Z} Uh {P}_{Im + {s}_{c}}^{′ T}}{{e}^{Z} Uh {P}_{Im + {s}_{c}}^{′ T} + {e}^{Z} Uh {P}_{In}^{T}} ) + β \cdot log ( \frac{{e}^{Z} Uh {z}_{Im + {s}_{w}}^{′ T}}{{e}^{Z} Uh {z}_{Im + {s}_{w}}^{′ T} + {e}^{Z} Uh {Z}_{In}^{T}} ) ) \qquad ( 11 )$$

wherein O represents a training data set, |O| represents the number of triplets in the training data set, uₕ in a triplet (uₕ, iₘ, iₙ) represents a h-th sample user, iₘ represents a m-th positive sample object that has interaction behavior with the h-th sample user, iₙ represents a n-th negative sample object that does not have interaction behavior with the h-th sample user, α and β can represent weight coefficients, Z_{Uh} represents collaborative features of the h-th sample user,

$${P}_{Im}^{′ T}$$

represents a transposed vector of content features of a m-th first positive sample object generated from prediction,

$${P}_{In}^{T}$$

represents a transposed vector of content features of a n-th first negative sample object from prediction,

$${Z}_{Im}^{′ T}$$

represents a transposed vector of collaborative features of a m-th second positive sample object, and

$${Z}_{In}^{T}$$

represents a transposed vector of collaborative features of a n-th second negative sample object.

The second loss function can be used to constrain the collaborative features and the content features of the sample objects to be consistent.

The second loss value L_{S} can be calculated, for example, according to the following second loss function formula (12):

$${L}_{S} = \frac{1}{⌈ I ⌉} {\sum }_{x ∈ I} {( 1 - cos ( {( \vert arcos ( \frac{{P}_{Ix} {Z}_{IX}^{T}}{{‖ {P}_{Ix} ‖}_{2} {‖ {Z}_{Ix} ‖}_{2}} ) \vert - φ , 0 )}_{max} ) )}^{3} \qquad ( 12 )$$

P_{Ix} represents content features of a first sample object x,

$${Z}_{IX}^{T}$$

represents a transposed vector of collaborative features of a second sample object that meets a third similarity condition with the first sample object x, and φ represents an angle constant. If an angle between P_{Ix} and Z_{Ix} is less than or equal to φ, the calculated second loss value L_{S} is 0.

Apparently, the method of calculating the first loss value and the second loss value is not limited to the above formula of calculation.

In addition, in implementations, a hybrid training method can be adopted, and sample objects and sample users are randomly selected from a training data set at each time of training to improve the generalization capability, robustness, and diversity of the second feature network, reduce the risk of overfitting, and improve the interpretability of the second feature network.

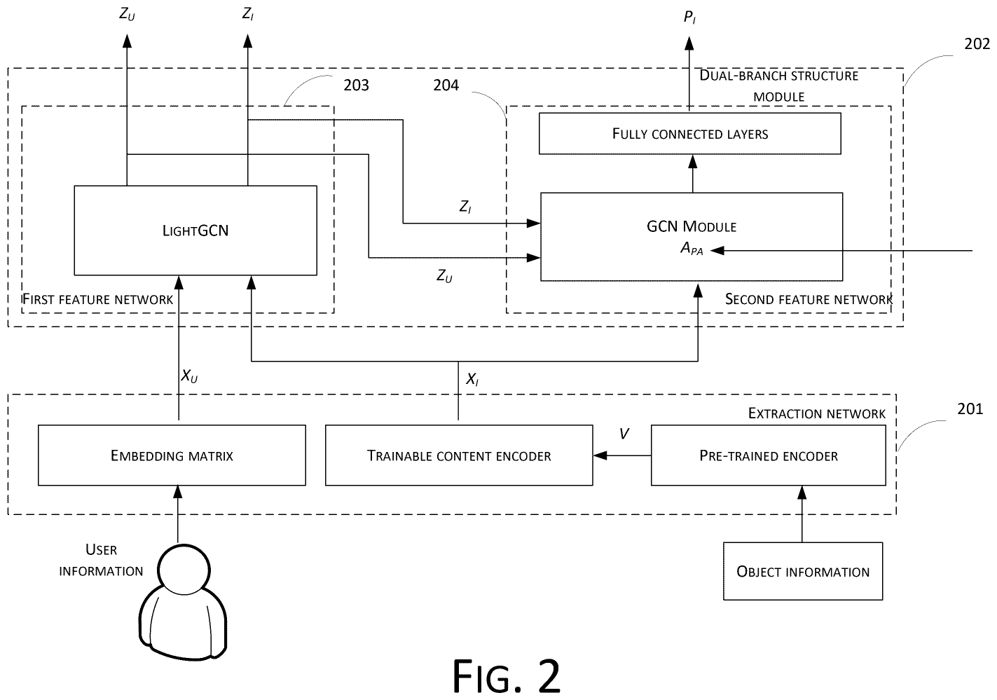

For ease of understanding, FIG. 2 shows a structure diagram of an exemplary model in a practical application according to the present disclosure. The structure diagram of such model includes an extraction network 201 and a dual-branch structure module 202, and the dual-branch structure module 202 includes a first feature network 203 and a second feature network 204.

User information of sample users and object information of sample objects can be input into the extraction network 201, and the extraction network 201 can use an embedding matrix to extract user features of the sample users from the user information of the sample users to generate user features X_{U}. The extraction network 201 can also use a frozen pre-trained encoder and a trainable content encoder composed of two fully connected layers to extract object features from the object information of the sample objects that is input to generate object features X_{I}. Furthermore, object features of second sample objects and the user features X_{U} of the sample users are input into the first feature network 203. In addition, according to first association relationship between the sample users and the second sample objects, edges between the sample users and the second sample objects can be constructed to generate a first adjacency matrix, and the first adjacency matrix is input into the first feature network 203.

The first feature network 203 uses LightGCN to process the object features of the second sample objects, the user featuress X_{U} of the sample users, and the first adjacency matrix that are input to generate collaborative features Z_{U} of the sample users and collaborative features Z_{I} of the second sample objects. The collaborative features Z_{U} of the sample users and the collaborative features Z_{I} of the second sample objects can be directly output, or input into the second feature network 204.

The object features of the first sample objects are input into the second feature network 204. In addition, feature similarities between the first sample objects and the second sample objects can be calculated, second association relationships between the first sample objects and second sample objects that meet a first similarity condition with the first sample objects can be established, and edges between the first sample objects and the second sample objects can be constructed based on the second association relationships between the first sample objects and the second sample objects to generate a first candidate adjacency matrix A_{c}, and third association relationships between the sample users and the first sample objects can be established based on a distribution of second sample objects that meet a second similarity condition with the first sample objects and have interactive behaviors with the sample users, and edges between the sample users and the first sample objects can be constructed based on the third association relationships between the sample users and the first sample objects to generate a second candidate adjacency matrix Aₚ. A second adjacency matrix A_{PA} obtained by combining the first candidate adjacency matrix and the second candidate adjacency matrix is input into the second feature network 204.

The second feature network 204 can use a GCN module to process the object features of the first sample objects, the second adjacency matrix A_{PA}, the collaborative features Z_{U} of the sample users, and the collaborative features Z_{I} of the second sample objects that are input to obtain candidate features of the first sample objects and candidate features of the second sample objects in each layer, and then perform fusion processing to obtain candidate features Q_{I} of the first sample objects, aggregate the candidate features Q_{I} of the first sample objects with the fully connected layer to obtain content features PI of the first sample objects, and output P_{I}.

Then, a triplet is determined to be composed of a sample user, a positive sample object that has an interactive behavior with the sample user, and a negative sample object that has no interactive behavior with the sample user. Based on collaborative features Z_{U} and content features P_{I} corresponding to triplets, a first loss value L_{R} is calculated using a first loss function such as the above formula (11). Based on content features of the first sample objects and collaborative features of second sample objects that satisfies a third similarity condition with the first sample objects, a second loss value L_{S} is calculated using a second loss function such as the above formula (12). Based on the first loss value L_{R} and the second loss value L_{S}, a target loss value is calculated in accordance with the above formula (10) in combination with a L2 loss value. Based on the target loss value L, model parameters corresponding to the first feature network and the second feature network are adjusted.

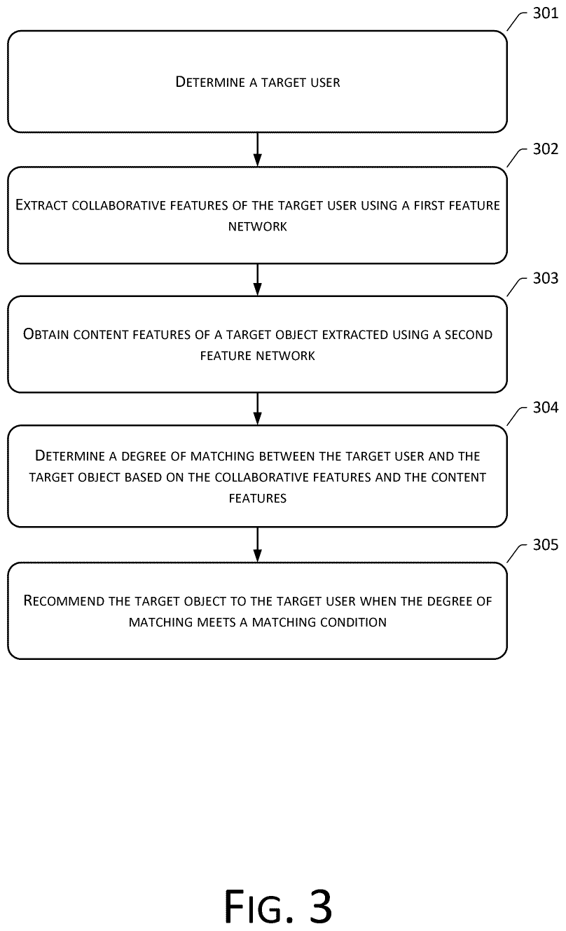

FIG. 3 is a flowchart of an exemplary recommendation method provided by the present disclosure. The technical solutions of the embodiments of the present disclosure can be applied to a server of an online system. The online system is usually composed of a user terminal, a client, and a server. The user terminal and the client are respectively connected to the server through a network. The network provides a medium for respective communication links for the user terminal and the client with the server. The network can include various connection types, such as wired, wireless communication links or optical fiber cables.

The client can be an object provider, and objects are published, for example, by the object provider. The user terminal can be consumer-oriented, so that users can perform interactive behaviors such as object search, purchase, browsing, etc.

The client and the user terminal can interact with the server through the network to receive or send messages, etc. For example, the client can perceive a category selection operation and a publishing operation of the object provider, and send corresponding requests to the server for the server to process accordingly. The user terminal can perceive an interactive behavior performed by a user, and send a corresponding interactive request to the server. The server can process the interactive request and feedback a processing result to the user terminal, etc.

The client or the user terminal can be a browser, an APP (Application), or a web application such as a H5 (HyperText Markup Language5, Hypertext Markup Language Version 5) application, or a light application (also known as applet, a lightweight application), or a cloud application, etc. The client or the user terminal can be deployed in an electronic device and needs to rely on the device or a certain app in the device to run, etc. For example, the electronic device may have a display screen and support information browsing, and may be, for example, a personal mobile terminal, such as a mobile phone, a tablet computer, a personal computer, a desktop computer, a smart speaker, a smart watch, etc.

The server as described above may include a server that provides various services, such as a server used for background training and providing support for models, or a server that processes information sent by the user terminal or the client, etc.

It needs to be noted that the server can be implemented as a distributed server cluster including multiple servers, or as a single server. The server can also be a server of a distributed system, or a server combined with a blockchain. The server can also be a cloud server that provides basic cloud computing services such as cloud services, cloud databases, cloud computing, cloud functions, cloud storage, network services, cloud communications, middleware services, domain name services, security services, content delivery networks (CDN), and big data and artificial intelligence platforms, etc., or an intelligent cloud computing server or intelligent cloud host with artificial intelligence technology.

The exemplary recommendation method as shown in FIG. 3 may include the following steps:

301: Determine a target user.

302: Extract collaborative features of the target user using a first feature network.

303: Obtain content features of a target object extracted using a second feature network.

304: Determine a degree of matching between the target user and the target object based on the collaborative features and the content features.

305: Recommend the target object to the target user when the degree of matching meets a matching condition.

The first feature network that uses user features of sample users, object features of second sample objects, and relational features representing first association relationships as input data, and the second feature network that uses object features of first sample objects, relational features representing second association relationships, and relational features representing third association relationships, as well as collaborative features of the sample users and collaborative features of the second sample objects generated by the first feature network as input data, are obtained by training in combination with training labels of whether the sample users have interaction behaviors with the second sample objects and the first sample objects respectively. A first association relationship is constructed according to whether a sample user has interaction behavior with a second sample object. A second association relationship is constructed according to whether a first sample object and a second sample object meet a first similarity condition. A third association relationship is constructed according to a distribution of second sample objects that meet a second similarity condition with a first sample object and have interaction behaviors with a sample user.

It needs to be noted that specific methods of generating the first feature network and the second feature network can be found in detail in corresponding embodiments as described above, and will not be repeated herein.

The matching condition may refer to, for example, the degree of matching being greater than a matching threshold, etc. When the collaborative features of the target user and the content features of the target object are in vector form, the degree of matching may refer to, for example, a vector distance, etc., which can be determined by calculating a cosine similarity, an Euclidean distance, a Pearson correlation coefficient, or a Hatton distance, etc.

In the embodiments of the present disclosure, an association relationship between a first sample object and a second sample object is constructed according to an object similarity. An association relationship between a second sample object and a sample user is constructed through historical interaction information between the second sample object and the sample user. An association relationship between a first sample object and a sample user is constructed in combination with an object similarity and a distribution of second sample objects, so as to train and obtain a first feature network and a second feature network accordingly. As such, the first feature network can accurately extract collaborative features of a target user, and the second feature network can accurately extract content features of a target object, thereby improving the representation quality of the collaborative features and the content features, accurately matching the content features of the target object with the collaborative features of the target user, and helping to achieve accurate recommendation.

In implementations, the method may further include: extracting initial features of the target user using the extraction network based on user information of the target user. Extracting the collaborative features of the target user using the first feature network may include: extracting the collaborative features of the target user using the first feature network based on the initial features.

In implementations, there may be multiple implementations for determining the target user. As an optional method, the target user may be a target user who has successfully registered.

In implementations, the target user may be a target user who has entered a target page. The target page may include a promotion page, etc.

In implementations, the target user may be a target user who has performed a target behavior. The target behavior may include a search behavior, etc.

In implementations, the method may further include: extracting the content features of the target object using the second feature network in response to a publishing event of the target object.

In implementations, there may be multiple implementations for recommending the target object to the target user. As an optional method, recommendation prompt information of the target object may be sent to a user terminal of the target user.

In implementations, the recommendation prompt information of the target object may be sent based on an communication account corresponding to the target user. For example, the recommendation prompt information of the target object may be sent to the target user in a form of a text message.

In implementations, when the target user performs a search behavior, search results can be generated based on the target object and sent to the user terminal of the target user.

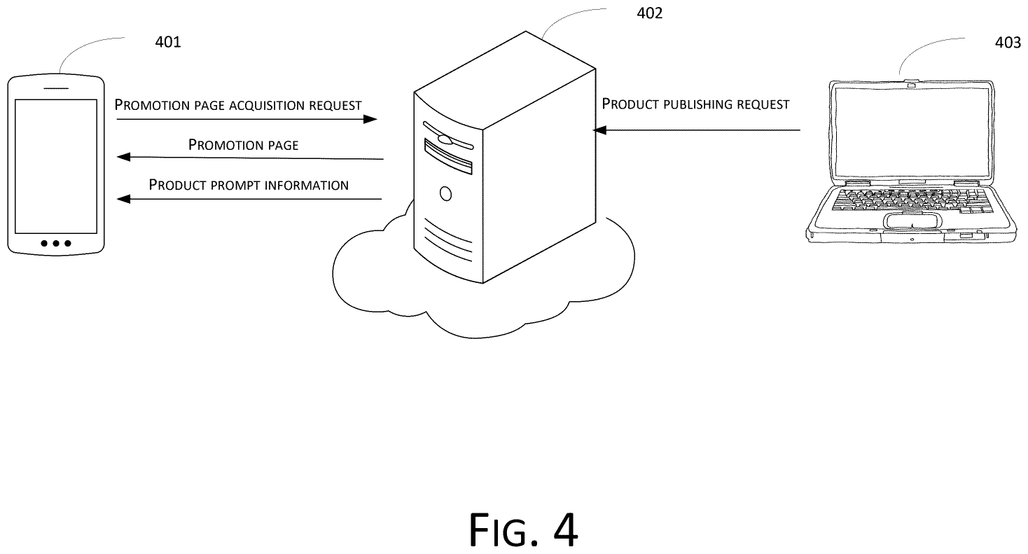

A practical application in an e-commerce scenario is used as an example to introduce the technical solutions of the present disclosure. In a scenario interaction diagram as shown in FIG. 4, a target user can request a promotion page from a server 402 through a user terminal 401. The user terminal 401 can display the promotion page, indicating that the target user enters the promotion page. The promotion page can refer to a target page for product recommendation.

A product provider requests the server 402 to publish products through a client 403, and the server 402 can extract content features of the products using a second feature network and store the content features.

After the target user enters the promotion page, the server 402 can extract collaborative features of the target user using a first feature network. The first feature network and the second feature network can be pre-trained by the server 402, etc., and apparently can also be trained by other training devices and deployed in the server 402, which is not limited by the present disclosure.

The server 402 can match the target user's collaborative features with content features of at least one recently released product, so as to determine z target product whose matching degree with the target user meets z matching condition. The server 402 can send product prompt information of the target product to a user 401. The user 401 can display the product prompt information in the promotion page, thus achieving the purpose of recommending the target product to the target user.

In the embodiments of the present disclosure, the first feature network can accurately extract collaborative features of a target user, and the second feature network can accurately extract content features of a target product, thereby improving the representation quality of the collaborative features and the content features, accurately matching the content features of the target product with the collaborative features of the target user, and helping to achieve accurate recommendation.

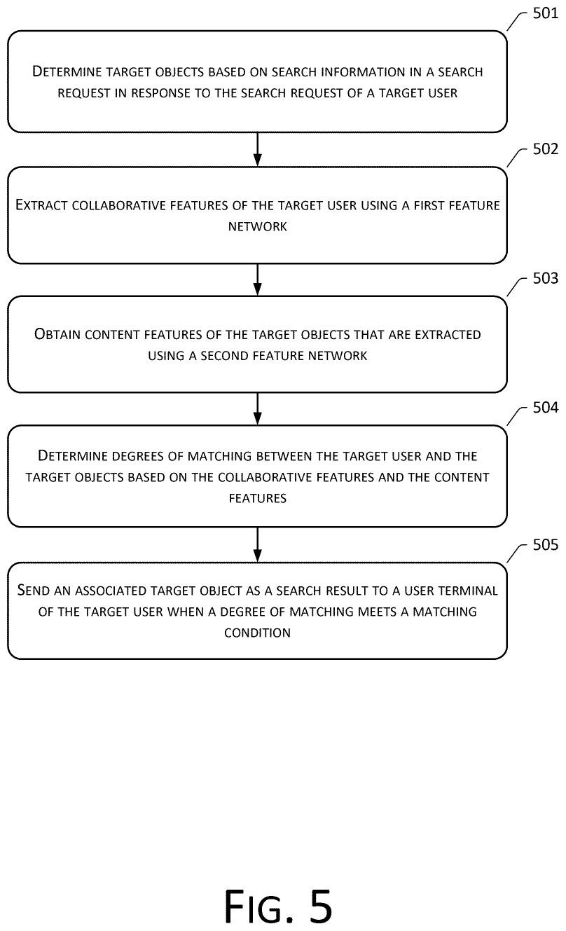

FIG. 5 is a flowchart of an exemplary search method provided by the present disclosure. The technical solutions of this embodiment can be applied to the server of an online system. The method may include the following steps:

501: Determine target objects based on search information in a search request in response to the search request of a target user.

For example, the search information may be a search keyword input by the user, and the server may determine target objects based on the search keyword.

502: Extract collaborative features of the target user using a first feature network.

503: Obtain content features of the target objects that are extracted using a second feature network.

504: Determine degrees of matching between the target user and the target objects based on the collaborative features and the content features.

505: Send an associated target object as a search result to a user terminal of the target user when a degree of matching meets a matching condition.

In other words, only the target object whose degree of matching with the target user meets the matching condition is used as the search result.

The first feature network that uses user features of sample users, object features of second sample objects, and relational features representing first association relationships as input data, and the second feature network that uses object features of first sample objects, relational features representing second association relationships, and relational features representing third association relationships, as well as collaborative features of the sample users and collaborative features of the second sample objects generated by the first feature network as input data, are obtained by training in combination with training labels of whether the sample users have interaction behaviors with the second sample objects and the first sample objects respectively. A first association relationship is constructed according to whether a sample user has interaction behavior with a second sample object. A second association relationship is constructed according to whether a first sample object and a second sample object meet a first similarity condition. A third association relationship is constructed according to a distribution of second sample objects that meet a second similarity condition with a first sample object and have interaction behaviors with a sample user.

It needs to be noted that specific methods of generating the first feature network and the second feature network can be found in detail in corresponding embodiments as described above, and will not be repeated herein.

In the embodiments of the present disclosure, a server responds to a search request of a target user, determines target objects based on search information in the search request, and uses target object(s) that meet(s) a matching condition as a search result. An association relationship between a first sample object and a second sample object is constructed according to an object similarity. An association relationship between a second sample object and a sample user is constructed through historical interaction information between the second sample object and the sample user. An association relationship between a first sample object and a sample user is constructed in combination with an object similarity and a distribution of second sample objects, so as to train and obtain a first feature network and a second feature network accordingly. As such, the first feature network can accurately extract collaborative features of a target user, and the second feature network can accurately extract content features of a target object, thereby improving the representation quality of the collaborative features and the content features, accurately matching the content features of the target object with the collaborative features of the target user, and achieving search results to be able to accurately match the user needs.

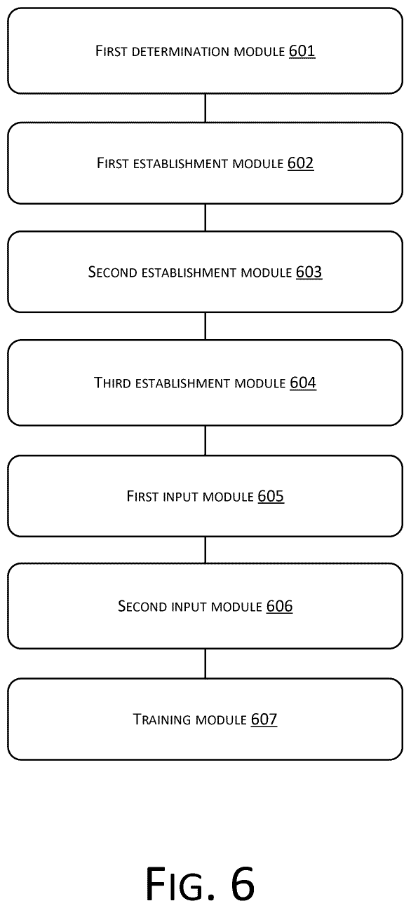

FIG. 6 is a schematic structural diagram of an exemplary model training apparatus provided by the present disclosure, wherein the apparatus includes:
a first determination module 601 configured to determine a training data set, wherein the training data set includes first sample objects, second sample objects, and sample users;
a first establishment module 602 configured to establish first association relationships between the sample users and second sample objects that have an interactive behavior with the sample users;
a second establishment module 603 configured to establish second association relationships between the first sample objects and second sample objects that satisfy a first similarity condition with the first sample objects;
a third establishment module 604 configured to establish third association relationships between the first sample objects and the sample users according to a distribution of second sample objects that satisfy a second similarity condition with the first sample objects and have an interactive behavior with the sample users.
a first input module 605 configured to input user features of the sample users, object features of the second sample objects, and relational features representing the first association relationships into a first feature network;
a second input module 606 configured to input object features of the first sample objects, relational features representing the second association relationships, relational features representing the third association relationships, and collaborative features of the sample users and collaborative features of the second sample objects generated by the first feature network into a second feature network; and
a training module 607 configured to train the first feature network and the second feature network using training labels of whether the sample users have interaction behaviors with the second sample objects and the first sample objects respectively.

The first feature network is used to extract collaborative features of a target user, and the second feature network is used to extract content features of a target object. A matching result of the content features and the collaborative features can be used to determine whether to recommend the target object to the target user.

In implementations, the apparatus can also use an extraction network to extract the object features of the first sample objects from object information of the first sample objects, extract the object features of the second sample objects from object information of the second sample objects, and extract the user features of the sample users from user information of the sample user.

In implementations, the extraction network, the first feature network, and the second feature network can be trained together. Training, by the training module, the first feature network and the second feature network using the training labels of whether the sample users have the interactive behaviors with the second sample objects and the first sample objects respectively may include: training the extraction network, the first feature network, and the second feature network using the training labels of whether the sample users have the interactive behaviors with the second sample objects and the first sample objects respectively.

In implementations, the first feature network can be implemented as a graph convolutional network. The first input module inputting the user features of the sample users, the object features of the second sample objects, and the relational features representing the first association relationships into the first feature network may include: using the user features of the sample users and the object features of the second sample objects as nodes to generate a first node feature matrix; constructing edges between the sample users and the second sample objects based on the first association relationships between the sample users and the second sample objects to generate a first adjacency matrix; and inputting the first node feature matrix and the first adjacency matrix into the first feature network.

In implementations, the first input module inputting the user features of the sample users, the object features of the second sample objects, and the relational features representing the first association relationships into the first feature network may include inputting the user features of the sample users, the object features of the second sample objects, and the relational features representing the first association relationships into the first feature network, so as to use the first feature network to generate, for any second sample object, collaborative features of the second sample object based on the object features of the second sample objects, the user features of the sample users having the first association relationships with the second sample objects, and the relational features of the first association relationships, and to generate, for any sample user, collaborative features of the sample user based on the user features of the sample users, the object features of the first sample objects having the first association relationships with the sample users, and the relational features.

In implementations, the second establishing module establishing the second association relationships between the first sample objects and the second sample objects that meet the first similarity condition with the first sample objects may include: calculating, for any first sample object, based on object features of the first sample object and object features of any second sample object, a feature similarity between the first sample object and the second sample object; and selecting a first number of second sample objects to establish association relationships with the first sample object in descending order of feature similarity.

In implementations, the third establishment module establishing the third association relationships between the sample users and the first sample objects based on the distribution of the second sample objects that meet the second similarity condition with the first sample objects and have interactive behaviors with the sample users may include: determining, for any first sample object and any sample user, a second number of second sample objects that meet the second similarity condition with the first sample objects; determining a third number of second sample objects that have the interactive behaviors with the sample users; determining a fourth number of second sample objects that meet the second similarity condition with the first sample objects and have the interactive behaviors with the sample users; calculating point mutual information based on respective occurrence probabilities of the second number of second sample objects, the third number of second sample objects, and the fourth number of second sample objects in the training data set; and establishing the third association relationships between the first sample objects and the sample users when the point mutual information is higher than a predetermined value.

In implementations, the second feature network may be a graph convolutional network.

The second input module inputting the object features of the first sample objects, the relational features representing the second association relationships, the relational features representing the third association relationships, and the collaborative features of the sample users and the collaborative features of the second sample objects generated by the first feature network into the second feature network may include: using the object features of the first sample objects as nodes to generate a second node feature matrix; using the collaborative features of the sample users generated by the first feature network as nodes to generate a third node feature matrix; using the collaborative features of the second sample objects as nodes to generate a fourth node feature matrix; constructing edges between the first sample objects and the second sample objects based on the second association relationships between the first sample objects and the second sample objects to generate a first candidate adjacency matrix; constructing edges between the sample users and the first sample objects based on the third association relationships between the sample users and the first sample objects to generate a second candidate adjacency matrix; combining the first candidate adjacency matrix and the second candidate adjacency matrix to obtain a second adjacency matrix; and inputting the second node feature matrix, the third node feature matrix, the fourth node feature matrix, and the second adjacency matrix into the second feature network.

Inputting the second node feature matrix, the third node feature matrix, the fourth node feature matrix, and the second adjacency matrix into the second feature network may include: inputting the second node feature matrix, the third node feature matrix, the fourth node feature matrix, and the second adjacency matrix into the second feature network, and performing feature processing operations in intermediate layers of the second feature network to obtain candidate features of the first sample objects and candidate features of the second sample objects; and fusing, in an output layer of the second feature network, the candidate features of the first sample object and the candidate features of the second sample object respectively output by the intermediate layers to obtain the content features of the first sample objects.

In implementations, in order to further improve the accuracy, the training module training the first feature network and the second feature network using the training labels of whether the sample users have the interactive behaviors with the second sample objects and the first sample objects respectively may include: in combination with the training labels of whether the sample users have interaction behaviors with the second sample objects and the first sample objects respectively, determining triplets including the sample users, first positive sample objects having interaction behaviors with the sample users, and first negative sample objects not having interaction behaviors with the sample users, and triplets including the sample users, second positive sample objects having interaction behaviors with the sample users, and second negative sample objects not having interaction behaviors with the sample users; calculating a first loss value using a first loss function according to collaborative features or content features corresponding to the triplets; calculating a second loss value using a second loss function according to content features of the first sample objects and collaborative features of the second sample objects that meet the third similarity condition with the first sample objects; determining a target loss value based on the first loss value and the second loss value; and adjusting respective model parameters corresponding to the first feature network and the second feature network based on the target loss value.

In implementations, the apparatus may further include one or more processors, an input/output (I/O) interface, a network interface, and a memory (not shown). In implementations, the memory may include program modules and program data. The program modules may include one or more of the foregoing modules as described in FIG. 6.

In implementations, the memory may include a form of computer readable media such as a volatile memory, a random access memory (RAM) and/or a non-volatile memory, for example, a read-only memory (ROM) or a flash RAM. The memory is an example of a computer readable media.

The computer readable media may include a volatile or non-volatile type, a removable or non-removable media, which may achieve storage of information using any method or technology. The information may include a computer readable instruction, a data structure, a program module or other data. Examples of computer readable media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

The model training apparatus described in FIG. 6 can execute the model training method described in the embodiments shown in FIG. 1, and its implementation principles and technical effects are not repeated herein. Specific methods in which each module and unit performs operations in the model training apparatus in the foregoing embodiments have been described in detail in the exemplary method, and will not be elaborated herein.

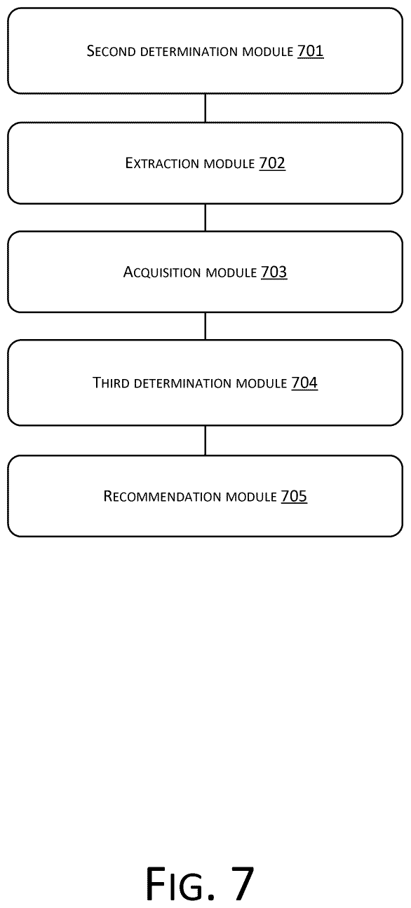

FIG. 7 is a schematic structural diagram of an exemplary recommendation apparatus provided by the present disclosure, and the apparatus includes:
a second determination module 701 configured to determine a target user;
an extraction module 702 configured to extract collaborative features of the target user using a first feature network;
an acquisition module 703 configured to obtain content features of a target object extracted using a second feature network;
a third determination module 704 configured to determine a degree of matching between the target user and the target object based on the collaborative features and the content features; and
a recommendation module 705 configured to recommend the target object to the target user when the degree of matching meets a matching condition.

The first feature network that uses user features of sample users, object features of second sample objects, and relational features representing first association relationships as input data, and the second feature network that uses object features of first sample objects, relational features representing second association relationships, and relational features representing third association relationships, as well as collaborative features of the sample users and collaborative features of the second sample objects generated by the first feature network as input data, are obtained by training in combination with training labels of whether the sample users have interaction behaviors with the second sample objects and the first sample objects respectively. A first association relationship is constructed according to whether a sample user has interaction behavior with a second sample object. A second association relationship is constructed according to whether a first sample object and a second sample object meet a first similarity condition. A third association relationship is constructed according to a distribution of second sample objects that meet a second similarity condition with a first sample object and have interaction behaviors with a sample user.

In implementations, the apparatus can also extract initial features of the target user using an extraction network based on user information of the target user. The extraction module extracting the collaborative features of the target user using the first feature network may include: extracting the collaborative features of the target user using the first feature network based on the initial features.

In implementations, the second determination module can determine the target user in multiple ways. As an optional way, the target user can be the target user who has successfully registered.

In implementations, the target user may be determined to enter a target page. The target page may include a promotion page, etc.

In implementations, the target user may be determined to perform a target behavior. The target behavior may include search behavior, etc.

In implementations, the apparatus may also be used to extract the content features of the target object using the second feature network in response to a publishing event of the target object.

In implementations, there are multiple implementation methods for the recommendation module to recommend the target object to the target user. As an optional method, recommendation prompt information of the target object may be sent to a user terminal of the target user.

In implementations, the recommendation prompt information of the target object may be sent based on a communication account corresponding to the target user. For example, the recommendation prompt information of the target object may be sent to the target user in a form of a text message.

In implementations, when the target user performs a search behavior, the target object may be sent to the user terminal of the target user as a search result.

In implementations, the apparatus may further include one or more processors, an input/output (I/O) interface, a network interface, and a memory (not shown). In implementations, the memory may include program modules and program data. The program modules may include one or more of the foregoing modules as described in FIG. 7. In implementations, the memory may include a form of computer readable media as described above.

The recommendation apparatus described in FIG. 7 may execute the recommendation method described in the embodiments as shown in FIG. 3, and its implementation principles and technical effects will not be repeated. Specific methods in which each module and unit performs operations in the model training apparatus in the foregoing embodiments have been described in detail in the exemplary method, and will not be elaborated herein.

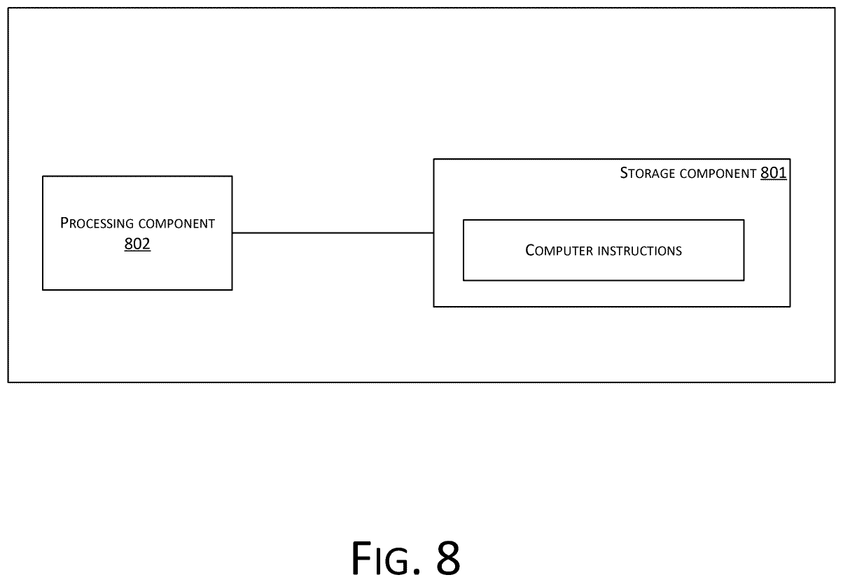

The embodiments of the present disclosure also provide a computing device, as shown in FIG. 8. The device may include a storage component 801 and a processing component 802.

The storage component 801 stores one or more computer instructions, wherein the one or more computer instructions are called and executed by the processing component to implement the model training method described in the embodiments as shown in FIG. 1, or the recommendation method described in the embodiments shown in FIG. 3, or the search method described in the embodiments as shown in FIG. 5.

Apparently, the computing device may also include other components, such as an input/output interface, a display component, a communication component, etc.

The input/output interface provides an interface between the processing component and a peripheral interface module. The peripheral interface module may be an output device, an input device, etc. The communication component is configured to facilitate wired or wireless communication between the computing device and other devices, etc.

The processing component 802 may include one or more processors to execute computer instructions to complete all or part of the steps in the above methods. Apparently, the processing component may also be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above methods.

The storage component 801 is configured to store various types of data to support operations at a terminal. The storage component can be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk, or optical disk.

The display component can be an electroluminescent (EL) element, a liquid crystal display or a micro display with a similar structure, or a retinal direct display or a similar laser scanning display.

It needs to be noted that the above-mentioned computing device can be a physical device or an elastic computing host provided by a cloud computing platform. It can be implemented as a distributed cluster composed of multiple servers or terminal devices, or can be implemented as a single server or a single terminal device.

It needs to be noted that when the above-mentioned computing device implements the model training method described in the embodiments as shown in FIG. 1, or the recommendation method described in the embodiments as shown in FIG. 3, or the search method described in the embodiments as shown in FIG. 5. It can be a physical device or an elastic computing host provided by a cloud computing platform. It can be implemented as a distributed cluster composed of multiple servers or terminal devices, or as a single server or a single terminal device. When the computing device implements the model training method described in the embodiments shown in FIG. 1, or the recommendation method described in the embodiments as shown in FIG. 3, or the search method described in the embodiments as shown in FIG. 5, it can be specifically implemented as an electronic device, which can refer to a device used by a user and has the functions of computing, surfing the Internet, communicating, etc. required by the user, such as a mobile phone, a tablet computer, a personal computer, a wearable device, etc.

The embodiments of the present disclosure also provide a computer-readable storage medium, which stores a computer program that, when the computer program is executed by a computer, can implement the model training method described in the embodiments as shown in FIG. 1, or the recommendation method described in the embodiments as shown in FIG. 3, or the search method described in the embodiments as shown in FIG. 5. The computer-readable medium can be included in the electronic device described in the above embodiments, or can exist alone without being assembled into the electronic device.

The embodiments of the present disclosure also provide a computer program product, which includes a computer program carried on a computer-readable storage medium, and the computer program, when executed by a computer, can implement the model training method described in the embodiments as shown in FIG. 1, or the recommendation method described in the embodiments as shown in FIG. 3, or the search method described in the embodiments as shown in FIG. 5. In such an embodiment, the computer program may be downloaded and installed from a network, and/or installed from a removable medium. When the computer program is executed by the processor, various functions defined in the system of the present disclosure are executed.

The computer-readable storage medium in corresponding embodiments as described above may be, for example, but not limited to, an electrical, magnetic, optical, electromagnetic, infrared, or semiconductor system, apparatus, device, or any combination of the above. More specific examples of computer-readable storage media may include, but are not limited to: an electrical connection with one or more wires, a portable computer disk, a hard disk, a random access memory (RAM), a read-only memory (ROM), an erasable programmable read-only memory (EPROM), a flash memory, an optical fiber, a portable compact disk read-only memory (Compact Disc Read-Only Memory, CD-ROM), an optical storage device, a magnetic storage device, or any suitable combination of the above. In the present disclosure, a computer-readable storage medium may be any tangible medium including or storing a program that can be used by or in conjunction with an instruction execution system, apparatus, or device.

One skilled in the art can clearly understand that, for the convenience and simplicity of description, specific working processes of the above-described systems, apparatuses and units can refer to corresponding processes in the aforementioned method embodiments, and will not be repeated herein.

The above-described apparatus embodiments are only schematic, wherein a unit described as a separate component may or may not be physically separated, and a component displayed as a unit may or may not be a physical unit, that is, may be located in one place, or may be distributed on multiple network units. Some or all of the modules can be selected according to actual needs to achieve the purposes of the solutions of the embodiments of the present disclosure. One of ordinary skill in the art can understand and implement them without making any creative effort.

Through the description of the above implementation methods, one skilled in the art can clearly understand that each implementation method can be implemented by means of software plus a necessary general hardware platform, and apparently can also be implemented by hardware. Based on this understanding, the essence of above technical solutions or the parts that contribute to existing technologies can be embodied in a form of a software product. Such computer software product can be stored in a computer-readable storage medium, such as ROM/RAM, a disk, an optical disk, etc., including a number of instructions to enable a computer device (which can be a personal computer, a server, or a network device, etc.) to execute the methods described in each embodiment or some parts of the embodiments.

Finally, it needs to be noted that the above embodiments are only used to illustrate, but not to limit the technical solutions of the present disclosure. Although the present disclosure is described in detail with reference to the above embodiments, one of ordinary skill in the art should understand that they can still modify the technical solutions recorded in the above embodiments, or replace some of the technical features therein by equivalent. These modifications or replacements do not make the essence of the corresponding technical solutions deviate from the spirit and scope of the technical solutions of the embodiments of the present disclosure.

What is claimed is:

1. A method implemented by a computing device, the method comprising:
determining a training data set, the training data set including first sample objects, second sample objects, and sample users;
establishing first association relationships between the sample users and second samples object that have interactive behaviors with the sample users;
establishing second association relationships between the first sample objects and second sample objects that meet a first similarity condition with the first sample objects;
establishing third association relationships between the first sample objects and the sample users based on a distribution of second sample objects that meet a second similarity condition with the first sample objects and have interactive behaviors with the sample users;
inputting user features of the sample users, object features of the second sample objects, and relational features representing the first association relationships into a first feature network;
inputting object features of the first sample objects, relational features representing the second association relationships, relational features representing the third association relationships, and collaborative features of the sample users and collaborative features of the second sample objects generated by the first feature network into a second feature network; and
training the first feature network and the second feature network using training labels of whether the sample users have interactive behaviors with the second sample objects and the first sample objects respectively.

2. The method according to claim 1, wherein the first feature network is used to extract collaborative features of a target user, the second feature network is used to extract content features of a target object, and a matching result of the content features and the collaborative features is used to determine whether to recommend the target object to the target user.

3. The method according to claim 1, further comprising:
using an extraction network to extract the object features of the first sample objects from object information of the first sample objects, extract the object features of the second sample objects from object information of the second sample objects, and extract the user features of the sample users from user information of the sample users.

4. The method according to claim 3, wherein extracting the object features of the first sample objects, the object features of the second sample objects, and the user features of the sample users using the extraction network comprises:
extracting the object features of the first sample objects and the object features of the second sample objects using a first sub-extraction network; and
extracting the user features of the sample users using a second sub-extraction network.

5. The method according to claim 3, wherein training the first feature network and the second feature network using the training labels whether the sample users have the interactive behaviors with the second sample objects and the first sample objects respectively comprises:
training the extraction network, the first feature network, and the second feature network using the training labels of whether the sample users have the interactive behaviors with the second sample objects and the first sample objects respectively.

6. The method according to claim 1, wherein establishing the second association relationships between the first sample objects and the second sample objects that meet the first similarity condition with the first sample objects comprises:
for any first sample object, based on object features of the first sample object and object features of any second sample object, calculating a feature similarity between the first sample object and the second sample object; and
selecting a first number of second sample objects in a descending order of feature similarity to establish association relationships with the first sample object.

7. The method according to claim 1, wherein establishing the third association relationships between the first sample objects and the sample users based on the distribution of the second sample objects that meet the second similarity condition with the first sample objects and have the interactive behaviors with the sample users comprises:
determining, for any first sample object and any sample user, a second number of second sample objects that meet the second similarity condition with the first sample object;
determining a third number of second sample objects that have interactive behaviors with the sample user;
determining a fourth number of second sample objects that meet the second similarity condition with the first sample object and have interactive behaviors with the sample user;
calculating point mutual information according to respective occurrence probabilities of the second number of second sample objects, the third number of second sample objects, and the fourth number of second sample objects in a training data set; and
establishing a third association relationships between the first sample object and the sample user when the point mutual information is higher than a predetermined value.

8. The method according to claim 1, wherein:
the first feature network is a graph convolutional network; and
inputting the user features of the sample users, the object features of the second sample objects and the relational features representing the first association relationships into the first feature network comprises:
using the user features of the sample users and the object features of the second sample object as nodes to generate a first node feature matrix;
constructing edges between the sample users and the second sample objects to generate a first adjacency matrix according to the first association relationships between the sample users and the second sample objects; and
inputting the first node feature matrix and the first adjacency matrix into the first feature network.

9. The method according to claim 1, wherein:
the second feature network is a graph convolutional network; and
inputting the object features of the first sample objects, the relational features representing the second association relationships, the relational features representing the third association relationships, the collaborative features of the sample users and the collaborative features of the second sample objects generated by the first feature network into the second feature network comprises:
using the object features of the first sample objects as nodes to generate a second node feature matrix;
using the collaborative features of the sample users generated by the first feature network as nodes to generate a third node feature matrix;
using the collaborative features of the second sample objects as nodes to generate a fourth node feature matrix;
constructing edges between the first sample objects and the second sample objects to generate a first candidate adjacency matrix based on the second association relationships between the first sample objects and the second sample objects;
constructing edges between the sample users and the first sample objects to generate a second candidate adjacency matrix based on the third association relationships between the sample users and the first sample objects;
combining the first candidate adjacency matrix and the second candidate adjacency matrix to obtain a second adjacency matrix; and
inputting the second node feature matrix, the third node feature matrix, the fourth node feature matrix, and the second adjacency matrix into the second feature network.

10. The method according to claim 9, wherein inputting the second node feature matrix, the third node feature matrix, the fourth node feature matrix, and the second adjacency matrix into the second feature network comprises:
inputting the second node feature matrix, the third node feature matrix, the fourth node feature matrix and the second adjacency matrix into the second feature network, and performing feature processing operations in intermediate layers of the second feature network to obtain candidate features of the first sample objects and candidate features of the second sample objects; and
fusing, in an output layer of the second feature network, the candidate features of the first sample object and the candidate features of the second sample object respectively output by the intermediate layers to obtain content features of the first sample objects.

11. The method according to claim 1, wherein training the first feature network and the second feature network using the training labels of whether the sample users have interaction behaviors with the second sample objects and the first sample objects respectively comprises:
using the training labels of whether the sample users have interaction behaviors with the second sample objects and the first sample objects respectively, determining triplets composed of the sample users, respective first positive sample objects having interaction behaviors with the sample users, and respective first negative sample objects having no interaction behaviors with the sample users, and triplets composed of the sample users, second positive sample objects having interaction behaviors with the sample users, and second negative sample objects having no interaction behaviors with the sample users;
calculating a first loss value using a first loss function according to collaborative features or content features corresponding to the triplets;
calculating a second loss value using a second loss function according to content features of the first sample objects and collaborative features of the second sample objects that meet a third similarity condition with the first sample objects;
determining a target loss value according to the first loss value and the second loss value; and
adjusting model parameters corresponding to the first feature network and the second feature network respectively based on the target loss value.

12. The method according to claim 1, wherein inputting the user features of the sample users, the object features of the second sample objects, and the relational features representing the first association relationships into the first feature network comprises:
inputting the user features of the sample users, the object features of the second sample objects, and the relational features representing the first association relationship into the first feature network, so as to use the first feature network to generate, for any second sample object, collaborative features of the second sample object based on the object features of the second sample objects, the user features of the sample users having the first association relationships with the second sample objects, and the relational features representing the first association relationships, and to generate, for any sample user, collaborative features of the sample user based on the user features of the sample users, the object features of the first sample objects having the first association relationships with the sample users, and the relational features.

13. One or more computer readable media storing executable instructions that, when executed by one or more processors, cause the one or more processors to perform operations comprising:
determining a target user;
using a first feature network to extract collaborative features of the target user;
obtaining content features of the target object extracted by a second feature network;
determining a degree of matching between the target user and the target object based on the collaborative features and the content features; and
recommending the target object to the target user if the degree of matching meets a matching condition.

14. The one or more computer readable media according to claim 13, wherein by training in combination with training labels of whether sample users have interaction behaviors with second sample objects and first sample objects respectively, the first feature network is obtained using user features of the sample users, object features of the second sample objects, and relational features representing first association relationships as input data, and the second feature network is obtained using object features of the first sample objects, relational features representing second association relationships, relational features representing third association relationships, and collaborative features of the sample users and collaborative features of the second sample objects generated by the first feature network as input data; the first association relationships are constructed based on whether the sample users have interaction behaviors with the second sample objects; the second association relationships are constructed based on whether the first sample objects and the second sample objects meet a first similarity condition; and the third association relationships are constructed based on a distribution of the second sample objects that meet a second similarity condition with the first sample objects and have interaction behaviors with the sample users.

15. The one or more computer readable media according to claim 13, the operations further comprising:
extracting initial features of the target user using an extraction network based on user information of the target user, wherein:
using the first feature network to extract the collaborative features of the target user comprises:
extracting the collaborative features of the target user using the first feature network based on the initial features.

16. The one or more computer readable media according to claim 13, wherein determining the target user comprises:
determining a target user who has successfully registered or entered a target page or performed a target behavior.

17. The one or more computer readable media according to claim 13, the operations further comprising:
extracting the content features of the target object using the second feature network in response to a publishing event of the target object.

18. The one or more computer readable media according to claim 13, wherein recommending the target object to the target user comprises:
sending recommendation prompt information of the target object to a user terminal of the target user; or
sending the recommendation prompt information of the target object based on a communication account corresponding to the target user; or
sending the target object as a search result to the user terminal of the target user.

19. An apparatus comprising:
one or more processors; and
memory storing executable instructions that, when executed by the one or more processors, cause the one or more processors to perform operations comprising:
determining, in response to a search request of a target user, a target object based on search information in the search request;
using a first feature network to extract collaborative features of the target user;
obtaining content features of the target object extracted using a second feature network;
determining a degree of match between the target user and the target object based on the collaborative features and the content features; and
sending the target object as a search result to a user terminal of the target user if the degree of matching meets a matching condition.

20. The apparatus according to claim 19, wherein: by training in combination with training labels of whether sample users have interaction behaviors with second sample objects and first sample objects respectively, the first feature network is obtained using user features of the sample users, object features of the second sample objects, and relational features representing first association relationships as input data, and the second feature network is obtained using object features of the first sample objects, relational features representing second association relationships, relational features representing third association relationships, and collaborative features of the sample users and collaborative features of the second sample objects generated by the first feature network as input data; the first association relationships are constructed based on whether the sample users have interaction behaviors with the second sample objects; the second association relationships are constructed based on whether the first sample objects and the second sample objects meet a first similarity condition; and the third association relationships are constructed based on a distribution of the second sample objects that meet a second similarity condition with the first sample objects and have interaction behaviors with the sample users.
